(19) United States
(12) Patent Application Publication
(10) Pub. No.: US 2012/0044729 A1
(43) Pub. Date: Feb. 23, 2012

(54) BRIDGELESS COUPLED INDUCTOR BOOST POWER FACTOR RECTIFIERS

(75) Inventors: Charles Coleman, Fort Collins, CO (US); Ernest H. Wittenbreder, JR., Flagstaff, AZ (US)

(73) Assignee: MICROSEMI CORPORATION, Aliso Viejo, CA (US)

(21) Appl. No.: 13/215,862

(22) Filed: Aug. 23, 2011

Related U.S. Application Data
(60) Provisional application No. 61/376,178, filed on Aug. 23, 2010.

(51) Int. Cl. H02M 7/06

(52) U.S. Cl. 363/126

(57) ABSTRACT

A bridgeless power factor correction system may include an AC input having a first input terminal and a second input terminal, an inductor module coupled with the first input terminal, and a switching module coupled between the second input terminal and the inductor module. The switching module may comprise a bi-directional voltage blocking switch that is configured to selectively couple the inductor module with the AC input based on an output voltage and a phase difference between an input voltage waveform and an input current waveform. The switching module may also comprise an auxiliary network for reversing a winding current to achieve zero voltage switching. An output module may be coupled with the inductor module, and provide an output to a load. The inductor module may include a magnetically coupled inductor having a primary and secondary winding. The output module may include a full or half bridge rectifier.

### CROSS REFERENCES

This application claims priority to U.S. provisional patent application Ser. No. 61/376,178 entitled “BRIDGELESS COUPLED INDUCTOR BOOST POWER FACTOR RECTIFIERS,” filed on Aug. 23, 2010, the entire disclosure of which is incorporated herein by reference.

### BACKGROUND

The present disclosure is directed to power factor correction rectifier electronic circuits, and new circuits and methods for power factor correction in the absence of a bridge rectifier.

Power factor is a measurement that is commonly used in ac circuits to represent differences in the phases of voltage and current ac waveforms. In reactive ac circuits, the current waveform may lead, or lag, the voltage waveform. Zero or near zero phase differences between the voltage and current waveforms result in a power factor at or near one, while increasing phase differences between the current and voltage waveforms result in a lower power factor. Active power factor correction (PFC) techniques have been used for increasing the power factor in reactive ac circuits. Increasing the power factor in such systems can have the effect of reducing the total harmonic distortion in ac line currents, reducing the load of the power generating station, and increasing the real power delivered to the circuit thereby reducing the cost of the power consumed by the circuit.

### SUMMARY

Methods, systems, and devices are described for new bridgeless active PFC converters that achieve relatively high efficiency. Various exemplary circuit topologies are provided based on coupled and tapped inductor boost converters utilizing one or more bi-directional voltage blocking switch, which achieve relatively low conduction losses. Zero voltage switching implementations that achieve both comparatively low conduction losses and reduction or elimination of first order drain circuit turn on switching losses are also provided.

The present disclosure provides, in various aspects, a bridgeless power factor correction apparatus, comprising, an AC input having a first input terminal and a second input terminal, an inductor module coupled with the first input terminal, and a switching module coupled between the second input terminal and the inductor module. The switching module may comprise a bi-directional voltage blocking switch that is configured to selectively couple the inductor module with the AC input based on an output voltage and a phase difference between an input voltage waveform and an input current waveform. An output module may be coupled with the inductor module, and provide an output to a load that may be coupled with the output module. The inductor module may comprise a first winding coupled with the AC input and the switching module, and a second winding inductively coupled with the first winding and coupled with the output module. The inductor module may also comprise a tapped inductor, and the second winding is common to a portion of the primary winding. The output module may include a full or half bridge rectifier. PFC systems disclosed herein may also include zero voltage switching circuits through an auxiliary switch and auxiliary capacitor coupled between the first input terminal and the inductor module, the auxiliary switch configured to accomplish a reversal of current in the inductor module during an off time of the main switch to direct current in the inductor module towards the main switch to drive the main switch to zero volts during a turn on transition of the main switch.

### BRIEF DESCRIPTION OF THE DRAWINGS

A further understanding of the nature and advantages of the present invention may be realized by reference to the following drawings. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 is a block diagram illustration of a PFC system.

FIG. 2 illustrates a bridgeless isolated coupled inductor boost active PFC system with a full bridge secondary circuit according to an embodiment.

FIG. 3 illustrates exemplary first and second operational states for the circuit of FIG. 2 during a positive half cycle of the input ac power supply.

FIG. 4 illustrates exemplary first and second operational states for the circuit of FIG. 2 during a negative half cycle of the input ac power supply.

FIG. 5 illustrates a bridgeless isolated coupled inductor boost active PFC system with a half bridge secondary circuit according to an embodiment.

FIG. 6 illustrates exemplary first and second operational states for the circuit of FIG. 5 during a positive half cycle of the input ac power supply.

FIG. 7 illustrates exemplary first and second operational states for the circuit of FIG. 5 during a negative half cycle of the input ac power supply.

FIG. 8 illustrates a bridgeless isolated coupled inductor boost active PFC system with a half bridge secondary circuit and MOSFET switches according to an embodiment.

FIG. 9 illustrates a bridgeless isolated coupled inductor boost active PFC system with a full bridge secondary circuit and MOSFET switches according to an embodiment.

FIG. 10 illustrates a bridgeless isolated coupled inductor boost active PFC system with a full bridge secondary circuit and MOSFET switches according to an embodiment.

FIG. 11 illustrates a bridgeless non-isolated tapped inductor boost active PFC system with a half bridge secondary circuit according to an embodiment.

FIG. 12 illustrates a zero voltage switching bridgeless non-isolated tapped inductor boost active PFC system with a half bridge secondary circuit according to an embodiment.

FIG. 13 illustrates a zero voltage switching bridgeless isolated coupled inductor boost active PFC system with a full bridge secondary circuit according to an embodiment.

FIG. 14 illustrates a zero voltage switching bridgeless isolated coupled inductor boost active PFC system with a half bridge secondary circuit according to an embodiment.

### DETAILED DESCRIPTION

This description provides examples, and is not intended to limit the scope, applicability or configuration of the invention. Rather, the ensuing description will provide those skilled in the art with an enabling description for implementing embodiments of the invention. Various changes may be made in the function and arrangement of elements.

Thus, various embodiments may omit, substitute, or add various procedures or components as appropriate. For instance, it should be appreciated that various of the described operations may be performed in an order different than that described, and that various steps may be added, omitted or combined. Also, aspects and elements described with respect to certain embodiments may be combined in various other embodiments. It should also be appreciated that the following exemplary embodiments may individually or collectively be components of a larger system, wherein other procedures may take precedence over or otherwise modify their application.

Systems, devices, and methods are described for isolated and non-isolated bridgeless active power factor correction circuits with low conduction losses. A new single stage isolated bridgeless active power factor correction circuit with low conduction losses is provided. In some embodiments, power factor correction circuits are provided with both low conduction losses and zero voltage switching. Exemplary PFC circuits provide reduced conduction losses in a bridgeless configuration through the use of a bi-directional voltage blocking switch. Other exemplary PFC circuits provide an isolated system through the use of a coupled inductor with a bi-directional voltage blocking switch coupled between a primary winding of the inductor and an ac power source. An output module may provide rectification of the signal induced at a secondary winding of the coupled inductor to provide a rectified output voltage to a load that is couplable with the output module.

In traditional PFC rectifiers the ac line voltage is rectified with a bridge rectifier. The output of the bridge rectifier is a dc voltage. The active PFC circuit in such traditional rectifiers is a dc circuit that sees only one polarity of line voltage. The bridge rectifier in such circuits incurs conduction losses due to the forward voltage drop of the diodes that comprise the bridge rectifier. These losses can be on the order of 2% of the total power processed by the PFC rectifier. Active PFC circuits that eliminate the bridge rectifier have been developed, and are referred to as bridgeless PFC rectifiers. Accomplishing bridgeless PFC in some cases requires some extra components and, in some cases, creates some additional problems, such as a high degree of common mode noise. Furthermore, traditional bridgeless PFC circuits generally do not offer isolation and require more than one conversion stage to achieve an isolated output.

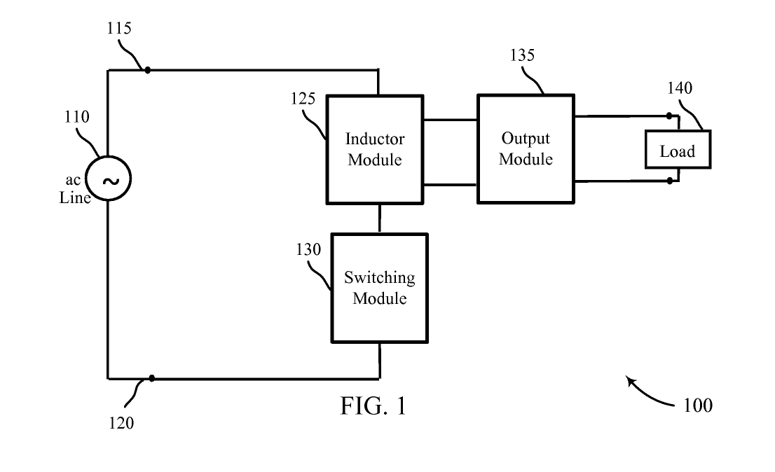

With reference first to FIG. 1, a block diagram of an exemplary PFC system 100 is described. In this example, an ac line 110 provides input alternating current (ac) power to the system 100. The ac line 110 provides input ac power at first input terminal 115 and second input terminal 120. The alternating current power may be any suitable alternating current type of supply, such as commonly available sinusoidally varying 120 Volt, 60 Hz, power commonly available in Japan and North America, or 230 Volt, 50 Hz, power commonly available in Europe, and other parts of the world. Of course, the ac power may also include non-sinusoidally varying input power, such as input power in which current and voltage waveforms have a triangle waveform, for example. As is well understood, and as discussed above, the input current and input voltage waveforms from ac line 110 may be out of phase, resulting in a decrease in power factor for power delivered to the system 100. Power factor may be increased in various embodiments through inductor module 125 and switching module 130. The inductor module 125 in the example of FIG. 1 is coupled with the first input terminal 115 and the switching module 130. The switching module 130, in turn, is coupled with the inductor module 125 and the second input terminal 120. An output module 135 is coupled with the inductor module 125. A load 140 is couplable with the output module 135.

The switching module 130 is configured to selectively couple the inductor module 125 with the second input terminal 120 in a manner that increases the power factor of the power provided from the inductor module 125 to the output module 135. In various examples, the switching module 130 receives a voltage level of the signal output from output module 135, as well as the phase difference between the input current and input voltage waveforms, and selectively couples the inductor module 125 with the second input terminal 120 in order to maintain a desired output voltage level and decrease the phase difference between the input current and input voltage waveforms. In various embodiments, the inductor module 125 includes a coupled inductor, thereby providing electrical isolation between the output module 135 and the ac line input 110. The switching module 130, in various embodiments, includes a bi-directional voltage blocking switch and a controller. As used herein, the term “switch” refers to an electrical circuit element that can have two electrical states, one of which substantially blocks current flow through the element and the other of which allows current flow through the element substantially unimpeded. Examples of switches include, for example, rectifier diodes, transistors, relays, and thyristors. The output module 135, in various embodiments, includes half or full bridge rectifiers, along with coupling and output capacitors.

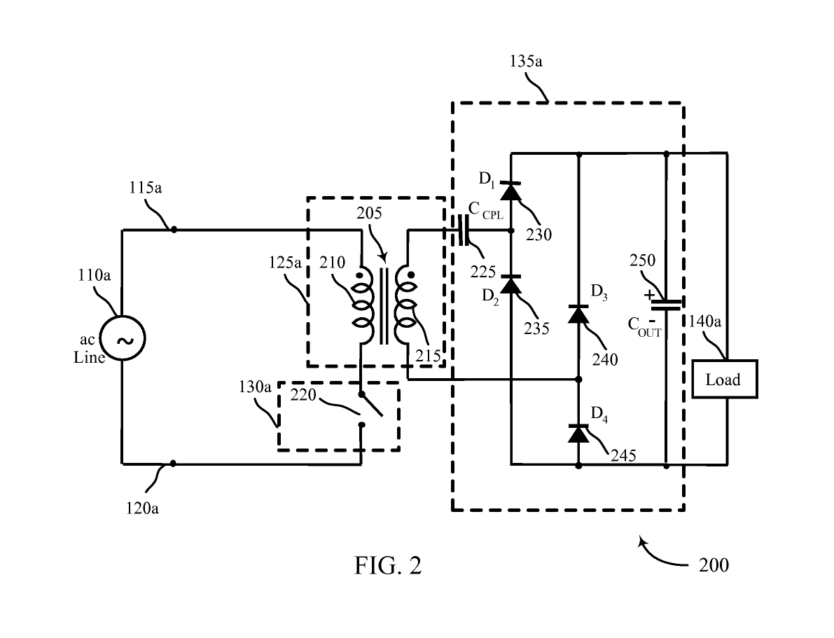

With reference now to FIG. 2, another exemplary power factor correction system 200 is illustrated. In this example, the inductor module 125a includes a coupled inductor 205 that includes a primary winding 210 and a secondary winding 215. The primary winding 210 has a dotted terminal and an undotted terminal. Similarly, the secondary winding 215 has a dotted terminal and an undotted terminal. In this embodiment, the dotted terminal of primary winding 210 is coupled with the first terminal 115a of AC Line 110a, and the undotted terminal is coupled with switch 220 of switching module 130a. The switch 220 operates to selectively couple the undotted terminal of the primary winding 210 with the second input terminal 120a. The output module 135a of this example includes a coupling capacitor 225 coupled between the dotted terminal of the secondary winding and a full bridge rectifier. The full bridge rectifier includes a first diode 230, a second diode 235, a third diode 240, and a fourth diode 245. The coupling capacitor 225 is coupled with the dotted terminal of secondary winding 215, and is coupled with the anode of first diode 230 and the cathode of second diode 235. The undotted terminal of secondary winding 215 is coupled with the anode of third diode 240 and the cathode of the fourth diode 245. An output capacitor 250 is coupled between the output terminals of output module 135a, in parallel with load 140a. In this example, the switch 220 is operated to selectively couple the undotted terminal of primary winding 210 with the second input terminal 120a based on a voltage level of the signal output from output module 135a, as well as the phase difference between the input current and input voltage waveforms. The switch 220 is operated to provide voltage and current waveforms on the primary winding 210 that have little or no phase difference, while maintaining a desired voltage difference at the output terminals of output module 135a. Similarly as discussed above, the switch 220 of this example may be a bi-directional voltage blocking switch, which can eliminate the need for a bridge on the primary side in inductor 205. In various traditional PFC circuits, one or more of a bridge or a flyback converter may be utilized. The exemplary system of FIG. 2 may have efficiencies compared to such systems, with the elimination of the bridge rectifier on the primary side of the inductor 205 enhancing the efficiency of the circuit of FIG. 2 by up to about 2% as compared to a system that utilizes a bridge rectifier. Furthermore, the use of coupled inductor 205 in a coupled inductor boost converter as illustrated in FIG. 2 may increase efficiency by up to about 5% as compared to a system that utilizes a traditional flyback converter.

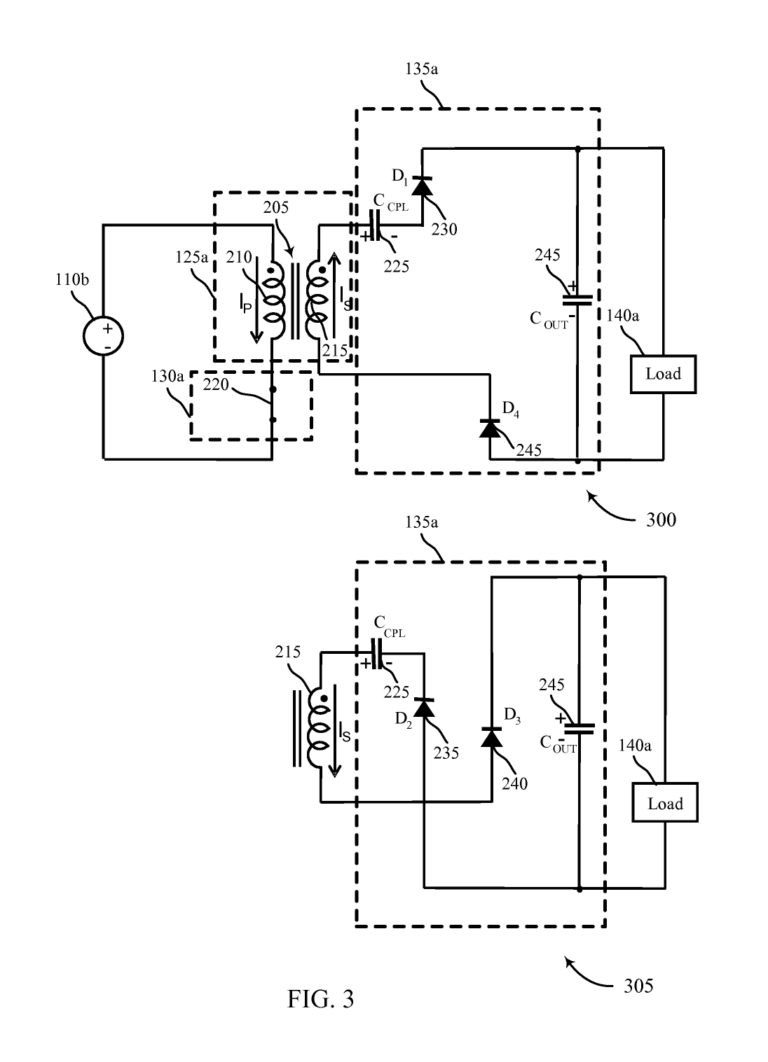

In operation of the PFC system of FIG. 2, there are four operating states. There are two positive half cycle operating states and two negative half cycle operating states. With reference now to FIG. 3, the two positive half cycle operating states are illustrated. In particular, FIG. 3 illustrates a first positive half cycle operating state 300 during an on time of the switch 220, and the second positive half cycle operating state 305 during an off time of the switch 220. In these positive half cycle operating states, AC line input 110b is positive, as illustrated in FIG. 3. According to the first positive half cycle operating state 300, switch 220 is closed, and current Iₚ is present through the primary winding 210, which induces current Iₛ in the secondary winding 215. In this example, coupling capacitor 225 accommodates voltages of two polarities. During the first positive half cycle 300, the first diode 230 and fourth diode 245 are forward biased. While in the first positive half cycle operating state 300, current Iₚ flows in the primary winding 210 as magnetizing current in inductor 205 ramps up. In addition to the magnetizing current in inductor 205, there are additional currents. A current Iₛ flows in secondary winding 215 induced through the magnetic coupling of the primary winding 210 and secondary winding 215. In addition to the magnetizing current in primary winding 210 an additional current related to Iₛ flows in primary winding 210. During the first positive half cycle operating state 300 the coupling capacitor 225 is charged and the output capacitor 250 is discharged as it supplies current to the load 140a. During the second positive half cycle operating state 305, the switch 220 is open, and thus no current flows through the primary winding 210. The magnetizing current Iₛ flows in the secondary winding 215 and the second diode 235 and third diode 240 are forward biased, with current in the second and third diodes 235, 240 ramping down as coupling capacitor 225 is discharged and output capacitor 250 is charged.

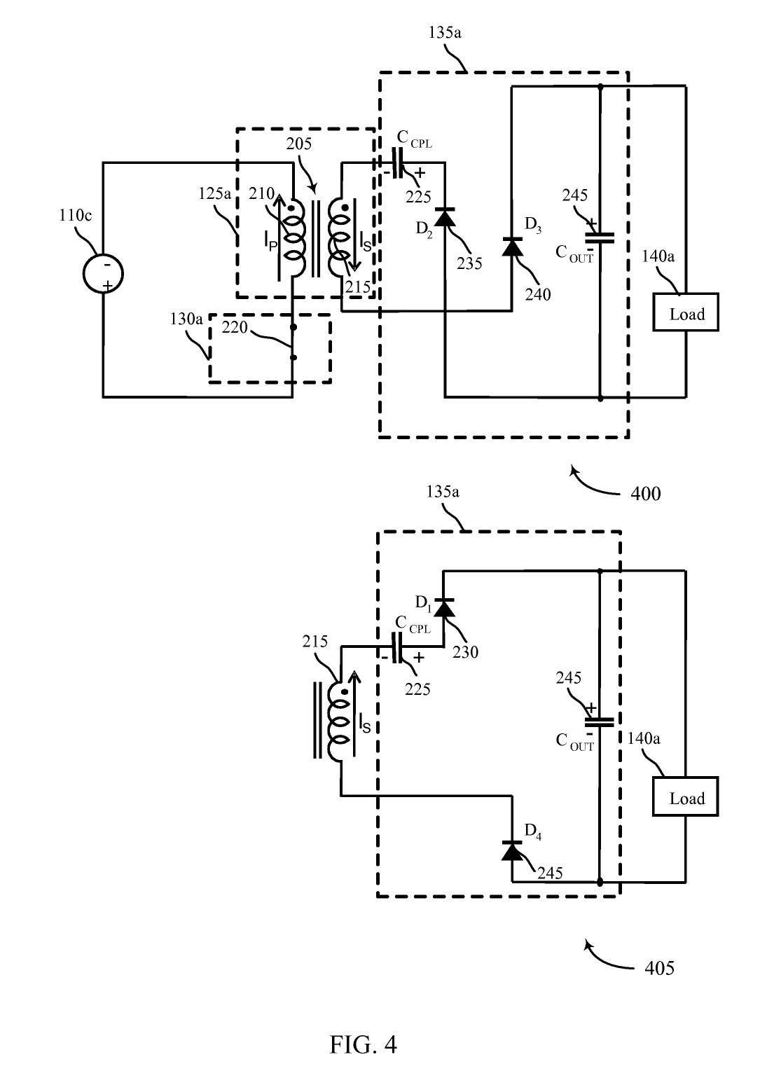

With reference now to FIG. 4, the two negative half cycle operating states are illustrated. In particular, FIG. 4 illustrates a first negative half cycle operating state 400 in which switch 220 is closed, and a second negative half cycle operating state 405 during which switch 220 is open. In these operating states, AC line input 110c is negative, as illustrated in FIG. 4. During a first negative half cycle operating state 400 the switch 220 is closed and current flows in the primary winding 210 of coupled inductor 205 as magnetizing current ramps up in coupled inductor 205. In the output module 135a, second and third diodes 235, 240 are forward biased, coupling capacitor 225 is discharged and output capacitor 250 is charged. The primary winding current Iₚ comprises both the magnetizing current and a current related to current Iₛ that flows in secondary winding 215. During the second negative half cycle operating state 405, the switch 220 is off, and no current flows in the primary winding 210 of the coupled inductor 205. During this operating state, the first diode 230 and the fourth diode 245 are forward biased as the magnetizing current in coupled inductor 205 ramps down and charges coupling capacitor 225. During the second negative half cycle operating state 405, output capacitor 250 discharges into the load.

The exemplary circuit and operating states of FIGS. 2-4 provide an efficient PFC system because the secondary winding 215 voltage is at or below the output voltage, thus resulting in a relatively small number of secondary winding turns, as compared to a comparable flyback converter in which the secondary winding voltage may exceed many times the output voltage and requires many more turns. Similarly, rectifier diodes 230, 235, 240, and 245, the diode voltage stresses remain at or below the output voltage, whereas in a flyback converter a diode with a voltage rating many times the output voltage would be implemented due to winding voltage that may exceed the output voltage by a significant amount. The switching module 130a in various examples includes a controller that controls the state of switch 220. The types of control that can be used in such embodiments include appropriate control modes used in active power factor correction, as will be readily understood by one of skill in the art, including average current mode control, voltage mode control, boundary mode control, and ZVS boundary mode control, to name a few examples.

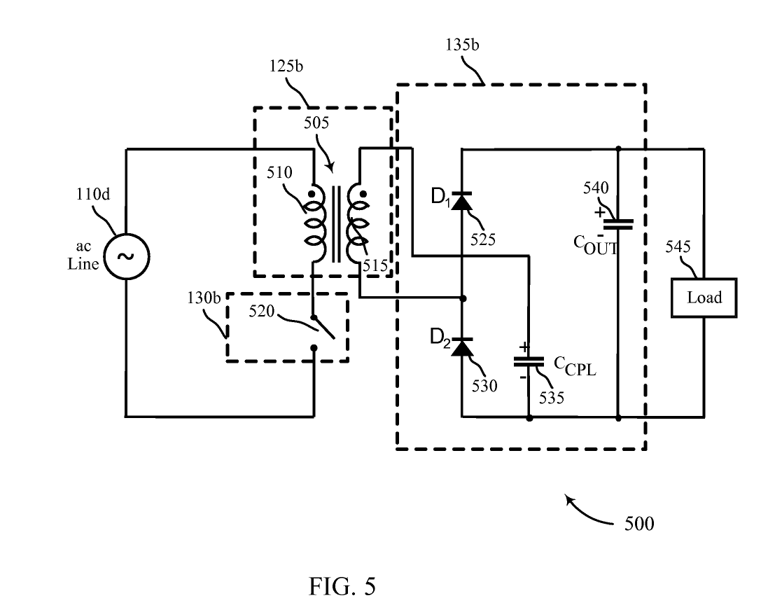

With reference now to FIG. 5, another exemplary PFC system 500 is illustrated. In this embodiment, inductor module 125b includes a magnetically coupled inductor 505 having a primary winding 510 and a secondary winding 515. The primary winding 510 includes a dotted terminal and an undotted terminal. Similarly, secondary winding 515 includes a dotted terminal and an undotted terminal. Switch module 130b includes a switch 520. Output module 135b in this example includes a half-bridge rectifier with a first diode 525 and a second diode 530, a coupling capacitor 535, and an output capacitor 540. A first terminal of an AC Line 110d is connected to the dotted terminal of primary winding 510 of the coupled inductor 505. The undotted terminal of the primary winding 510 of coupled inductor 505 is connected to a first terminal of switch 520. Switch 520 may include a bi-directional voltage blocking switch. A second terminal of switch 520 is coupled with a second terminal of the AC line 110d. The dotted terminal of secondary winding 515 of coupled inductor 505 is coupled with a positive terminal of coupling capacitor 535. The undotted terminal of the secondary winding 515 of coupled inductor 505 is coupled with an anode terminal of a first diode 525 and to a cathode terminal of second diode 530. An anode terminal of second diode 530 is connected to the negative terminal of coupling capacitor 535, to a negative terminal of a output capacitor 540, and to a first terminal of a load 545. A cathode terminal of first diode 525 is connected to a positive terminal of output capacitor 540 and to a second terminal of load 545.

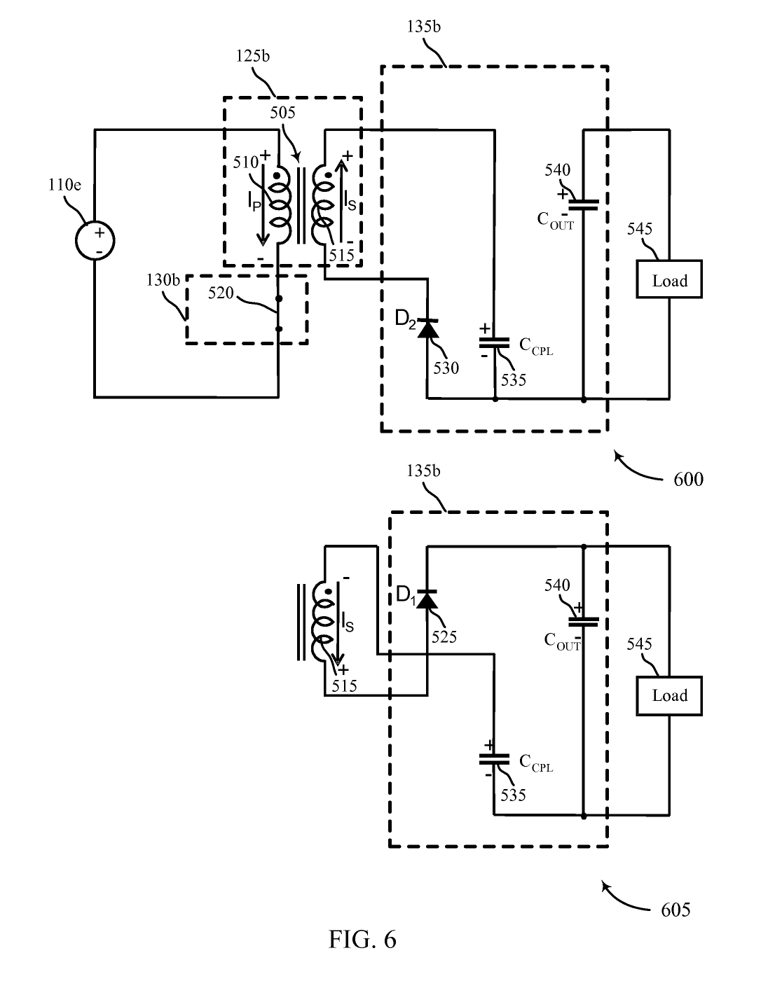

In operation, similarly as described above with respect to PFC system 200, there are four operating states. There are two positive half cycle operating states and two negative half cycle operating states. With reference now to FIG. 6, a first positive half cycle operating state 600, and a second positive half cycle operating state 605 are illustrated. During the first positive half cycle operating state 600, the switch 520 is closed and second diode 530 is forward biased. During the first positive half cycle operating state 600 current Iₚ flows in the primary winding 510 of coupled inductor 505 as magnetizing current ramps up in the coupled inductor 505. In addition to the magnetizing current in coupled inductor 505, there is an additional current Iₛ induced in secondary winding 515 due to the fact that the primary 510 and secondary 515 windings are magnetically coupled. During the first positive half cycle operating state 600 the coupling capacitor 535 is charged and the output capacitor 540 is discharged as it supplies current to the load 545. During a second positive half cycle operating state 605, switch 520 is open, thereby resulting in no current flow through primary winding 510. Magnetizing current Iₛ flows in the secondary winding 515 of coupled inductor 505 and in the first diode 525 and ramps down as coupling capacitor 535 is discharged and output capacitor 540 is charged.

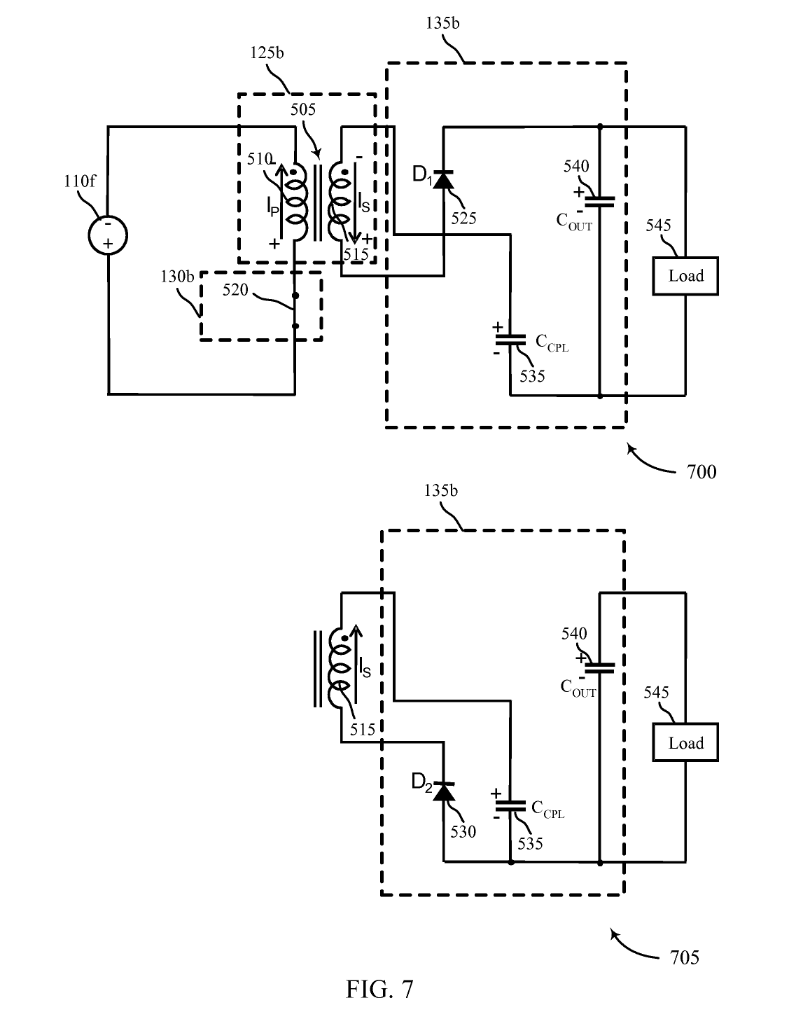

With reference now to FIG. 7, a first negative half cycle operating state 700, and a second negative half cycle operating state 705 are illustrated. During first negative half cycle operating state 700, the switch 520 is closed and current Iₚ flows in the primary winding 510 of coupled inductor 505, as magnetizing current ramps up in coupled inductor 505. In the output module 135b, first diode 525 is forward biased, coupling capacitor 535 is discharged and output capacitor 540 is charged. During the second negative half cycle operating state 705, the second diode 530 is forward biased and conducts current as the magnetizing current Is in secondary winding 515 of coupled inductor 505 ramps down and charges coupling capacitor 535. During the second negative half cycle operating state 705, switch 520 is open thereby resulting in no current flow through primary winding 510 of coupled inductor 505. Current Iₛ in secondary winding 515 flows to forward bias the second diode 530, and output capacitor 540 discharges into the load 545.

The exemplary PFC system 500 illustrated in FIGS. 5-7 is relatively efficient, as the secondary winding 515 voltage remains at or below the voltage level of the output voltage, resulting in relatively few secondary winding 515 turns, as compared to a comparable flyback converter in which the secondary winding voltage can exceed many times the output voltage and requires many more turns. Similarly, the rectifier diodes 525 and 530 have diode voltage stresses that remain at or below the output voltage level. In a typical flyback converter, a diode with a voltage rating many times the output voltage may be used. The switching module 130b in various examples includes a controller that controls the state of switch 520. The types of control that can be used in such embodiments include appropriate control modes used in active power factor correction, as will be readily understood by one of skill in the art, including average current mode control, voltage mode control, boundary mode control, and ZVS boundary mode control, to name a few examples.

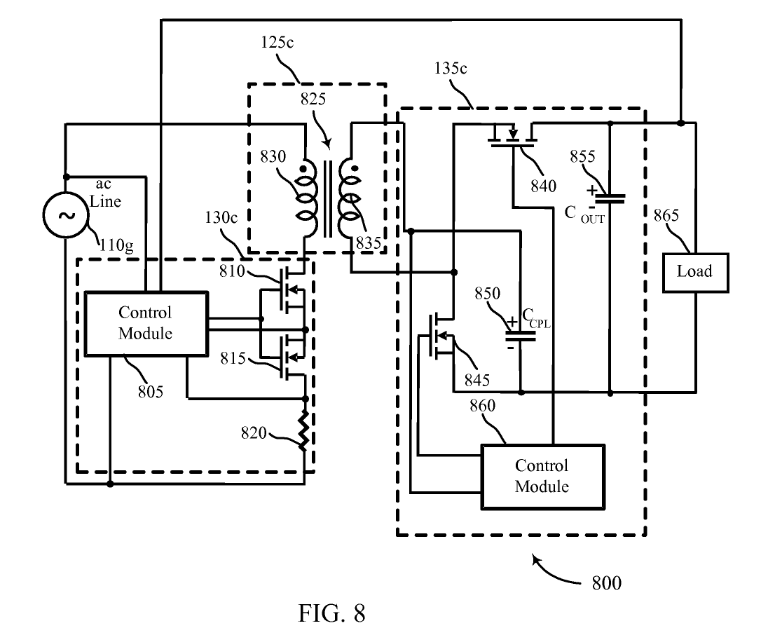

FIG. 8 illustrates a PFC system 800, similar to the system 500 of FIG. 5, in which the switching module 130c includes a control module 805 and a pair of source and gate connected MOSFETS 810 and 815. The pair of source and gate connected MOSFETS 810 and 815 in this example form a switch with bi-directional voltage blocking capability. The control module 805 is coupled with the input terminals and either side of AC line input 110g, an output terminal of output module 135c, and a sense resistor 820. The control module 805 controls the state of MOSFETs 810 and 815 based on the detected level of input current and voltage, output voltage, and a voltage present at the connection to sense resistor 820. Types of control that can be used in such embodiments include appropriate control modes used in active power factor correction, as will be readily understood by one of skill in the art, including average current mode control, voltage mode control, boundary mode control, and ZVS boundary mode control, to name a few examples. The inductor module 125c of this example includes coupled inductor 825 with primary winding 830 and secondary winding 835. The output module 135c includes a half bridge active rectifier with first rectifier switch 840 and second rectifier switch 845. The output module includes coupling capacitor 850, and output capacitor 855, similarly as described above with respect to FIGS. 5-7. Output module 135c also includes control module 860 coupled with the dotted terminal of secondary winding 835, and configured to turn on and off switches 840 and 845 to achieve appropriate rectification of the output voltage provided to load 865. The operating states for PFC system 800 are similar to those described above with respect to FIGS. 6-7.

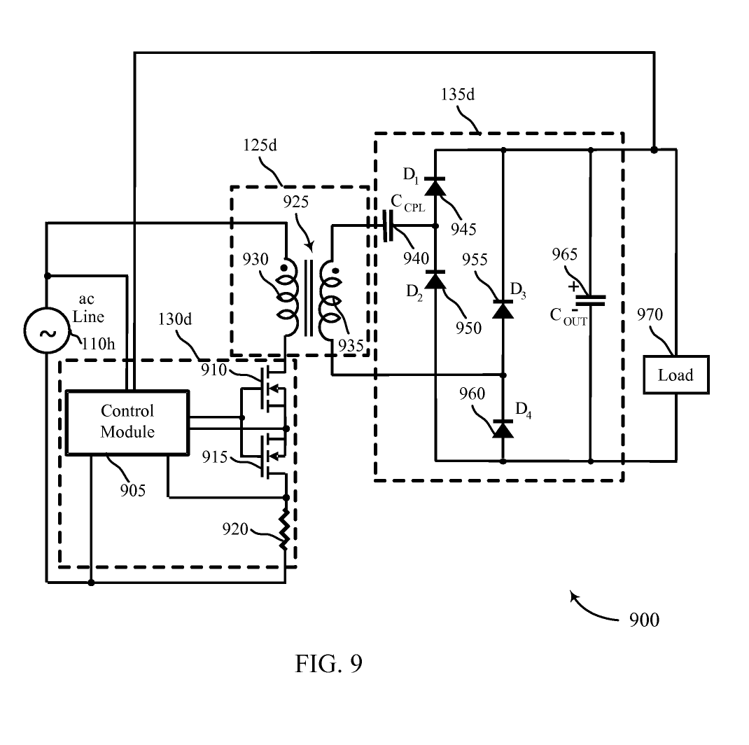

With reference now to FIG. 9, a PFC system 900, similar to the system 200 of FIG. 2, in which the switching module 130d includes a control module 905 and a pair of source and gate connected MOSFETS 910 and 915. The pair of source and gate connected MOSFETS 910 and 915 in this example form a switch with bi-directional voltage blocking capability. The control module 905 is coupled with either side of AC line input 110h, an output terminal of output module 135d, and a sense resistor 920. The control module 905 controls the state of MOSFETs 910 and 915 based on the detected level of input current and voltage, output voltage, and a voltage present at the connection to sense resistor 920. Types of control that can be used in such embodiments include appropriate control modes used in active power factor correction, as will be readily understood by one of skill in the art, including average current mode control, voltage mode control, boundary mode control, and ZVS boundary mode control, to name a few examples. The inductor module 125d of this example includes coupled inductor 925 with primary winding 930 and secondary winding 935. The output module 135d includes coupling capacitor 940 and full bridge diode rectifier with a first diode 945, a second diode 950, a third diode 955, and a fourth diode 960. The output module 135d includes an output capacitor 965 and is couplable to load 970. The operating states for PFC system 900 are similar to those described above with respect to FIGS. 3-4.

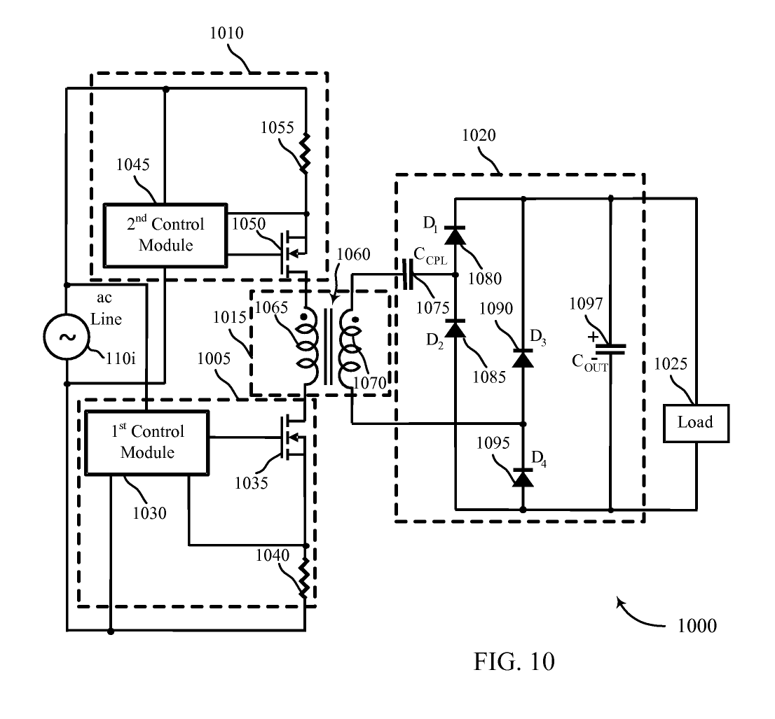

FIG. 10 illustrates another exemplary PFC system 1000, in which the switching is accomplished through switching modules 1005 and 1010. Switching modules are coupled to inductor module 1015, which is in turn coupled with output module 1020 and a load 1025. The switching module 1005 includes a first control module 1030, a MOSFET switch 1035, and a sense resistor 1040. Similarly, switching module 1010 includes a second control module 1045, a MOSFET switch 1050, and a sense resistor 1055. Inductor module 1015 includes a coupled inductor 1060 with primary winding 1065 and secondary winding 1070. Output module 1020 includes a full bridge rectifier, similar to output modules 135a and 135d. Output module 1020 includes coupling capacitor 1075 and full bridge diode rectifier with a first diode 1080, a second diode 1085, a third diode 1090, and a fourth diode 1095. The output module 135d includes an output capacitor 1097 and is couplable to load 1025. In the examples of FIGS. 8 and 9, the switches (130c and 130d) require a level shifting circuit or magnetically coupled driver to drive the main switch pair of MOSFETs. In the PFC system 1000, two control circuits 1030 and 1045 are provided, and a level shifting circuit would not be required. In this example, the first control module 1030 modulates switch 1035 during the positive half cycle and maintains switch 1035 on during the negative half cycle. During the negative half cycle, the second control module 1045 modulates switch 1050 and maintains switch 1050 on during the positive half cycle. The output module 1020 operates in a manner similarly as described for the operating states of FIGS. 3 and 4.

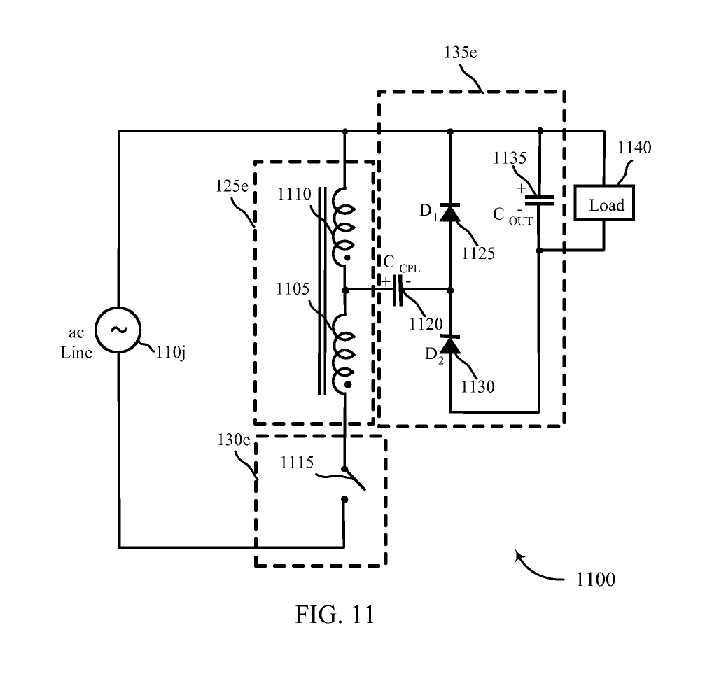

FIG. 11 illustrates a bridgeless active PFC tapped inductor boost converter system 1100 for non-isolated applications. In this example, inductor module 125e includes a tapped inductor with primary winding 1105 and a secondary winding 1110 that is realized by tapping the primary winding 1105 so that the secondary winding 1110 is shared with the primary winding 1105. During the on time of the switch 1115 both secondary current and primary current flow in the common winding 1105, but the two currents flow in opposite directions so that the total current in the common winding is reduced compared to the similar isolated circuit 500 of FIG. 5. Output module 135e of this example, includes a half bridge rectifier with first diode 1125, second diode 1130, coupling capacitor 1120, and output capacitor 1135. Output module 135e is couplable with load 1140. The result of the common winding 1105 is significantly reduced winding conduction losses in the common winding, relative to the isolated equivalent circuit of FIG. 5. The operating states of the system 1100 are similar to those described with respect to FIGS. 6 and 7.

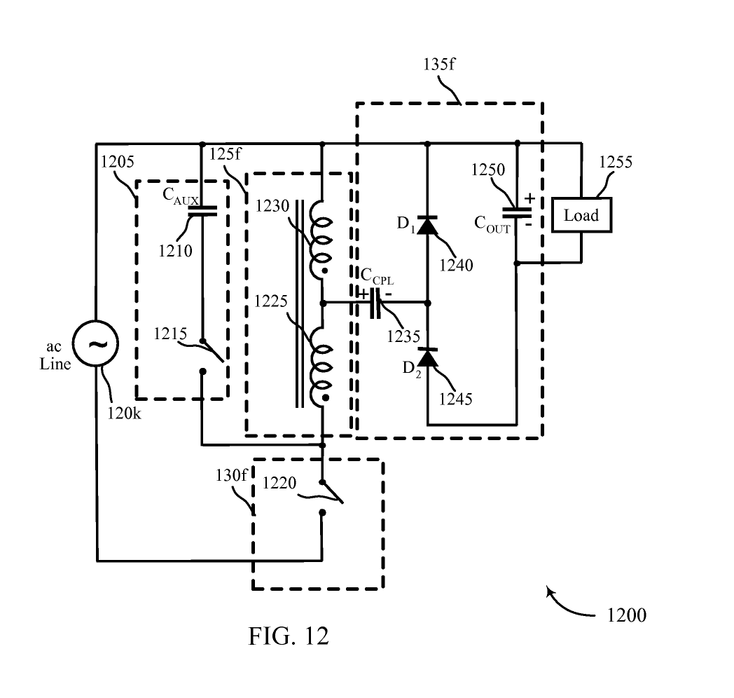

FIG. 12 illustrates an exemplary PFC system 1200 similar to the FIG. 11 example, that includes an active reset network 1205 as compared to the FIG. 11 example. The active reset network 1205 comprises an auxiliary switch 1215 and an auxiliary capacitor 1210. The auxiliary switch 1215 is operated substantially in anti-synchronization to the main switch 1220, except for brief dead times during the switching transitions when both switches 1215 and 1220 are off. In the steady state the current in the auxiliary switch 1215 reverses during the on time of the auxiliary switch 1215 so that the switch current is directed towards driving a zero voltage turn on transition for main switch 1220. The energy for driving the zero voltage turn on transition for main switch 1220 derives from series or leakage inductance stored energy and/or magnetizing energy of the coupled inductor in the inductor module 125f. At light loads the magnetizing energy of inductor module 125f will be the main source of zero voltage switching (ZVS) drive energy, but at heavy loads most of the energy will be derived from the series or leakage inductance. In this example, similar to the example of FIG. 11, inductor module 125f includes a tapped inductor with primary winding 1225 and a secondary winding 1230 that is realized by tapping the primary winding 1225 so that the secondary winding 1230 is shared with the primary winding 1225. During the on time of the main switch 1220 both secondary current and primary current flow in the common winding 1225, but the two currents flow in opposite directions so that the total current in the common winding 1225 is reduced compared to the similar isolated circuit 500 of FIG. 5. Output module 135f of this example, includes a half bridge rectifier with first diode 1240, second diode 1245, coupling capacitor 1235, and output capacitor 1250. Output module 135f is couplable with load 1255. The operating states of the system 1200 are similar to those described with respect to FIGS. 6 and 7.

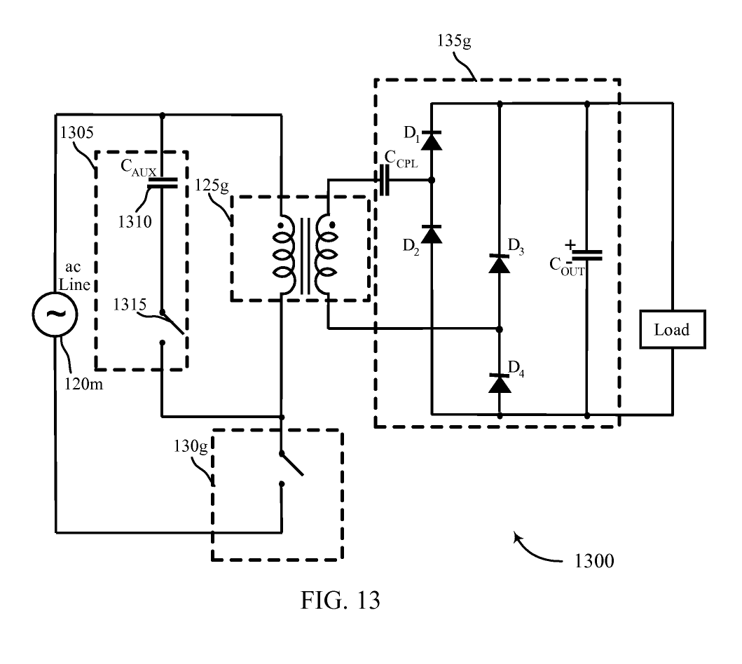

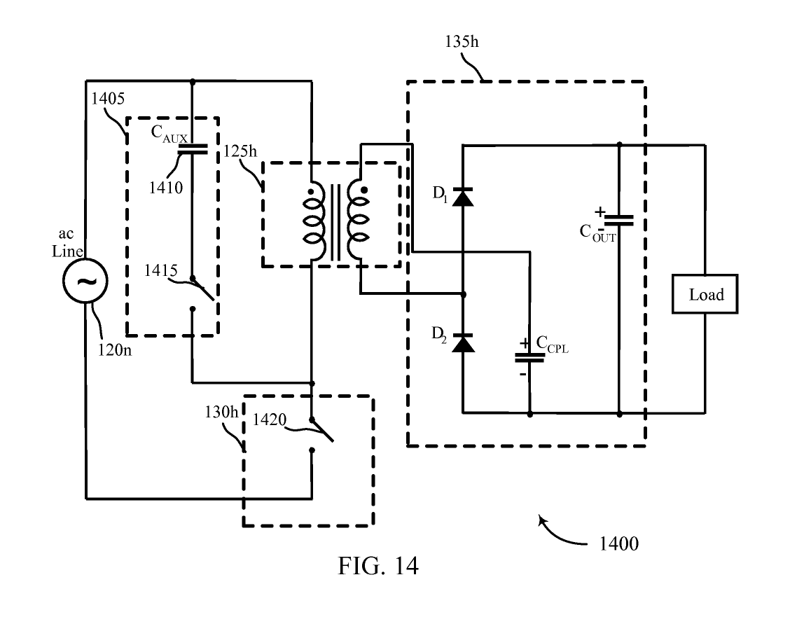

FIG. 13 illustrates another exemplary PFC system 1300 similar to the system of FIG. 2, but with an active clamp network 1305 for providing a ZVS drive mechanism through auxiliary capacitor 1310 an auxiliary switch 1315. FIG. 14 illustrates another PFC system 1400 similar to the FIG. 5 example, but with an active clamp network 1405 for providing a ZVS drive mechanism through auxiliary capacitor 1410 an auxiliary switch 1415. In the active clamp networks of the examples of FIGS. 12, 13, and 14, the auxiliary switch may comprise a switch with bi-directional voltage blocking capability.

While the above description contains many examples of PFC systems, these should not be construed as limitations on the scope of the invention, but rather, as exemplifications thereof. Many other variations are possible. For example, PFC systems may include circuits similar to the circuits shown but with polarity of the input or output reversed from that illustrated. PFC systems may also include circuits similar to those shown, but having coupled magnetic circuit elements with more than two windings and circuits with more than one output. In many of the illustrated circuits there are series connected networks. The order of placement of circuit elements in series connected networks is inconsequential in the described examples, so that series networks in the illustrated circuits with circuit elements reversed or placed in an entirely different order within series connected networks are equivalent to the circuits illustrated, as will be readily recognized by one skilled in the art. Also, some of the embodiments show N channel MOSFET switches, but the operation revealed and the benefits achieved may also be realized in circuits that implement the switches using P channel MOSFETs, IGBTs, JFETs, bipolar transistors, junction rectifiers, or schottky rectifiers.

These components may, individually or collectively, be implemented with one or more Application Specific Integrated Circuits (ASICs) adapted to perform some or all of the applicable functions in hardware. Alternatively, the functions may be performed by one or more other processing units (or cores), on one or more integrated circuits. In other embodiments, other types of integrated circuits may be used (e.g., Structured/Platform ASICs, Field Programmable Gate Arrays (FPGAs) and other Semi-Custom ICs), which may be programmed in any manner known in the art. The functions of various modules may also be implemented, in whole or in part, with instructions embodied in a memory, formatted to be executed by one or more general or application-specific processors.

It should be noted that the systems and devices discussed above are intended merely to be examples. It must be stressed that various embodiments may omit, substitute, or add various procedures or components as appropriate. Also, features described with respect to certain embodiments may be combined in various other embodiments. Different aspects and elements of the embodiments may be combined in a similar manner. Also, it should be emphasized that technology evolves and, thus, many of the elements are exemplary in nature and should not be interpreted to limit the scope of the invention.

Specific details are given in the description to provide a thorough understanding of the embodiments. However, it will be understood by one of ordinary skill in the art that the embodiments may be practiced without these specific details. For example, well-known circuits, processes, algorithms, structures, and techniques have been shown without unnecessary detail in order to avoid obscuring the embodiments.

Having described several embodiments, it will be recognized by those of skill in the art that various modifications, alternative constructions, and equivalents may be used without departing from the spirit of the invention. For example, the above elements may merely be a component of a larger system, wherein other rules may take precedence over or otherwise modify the application of the invention. Accordingly, the above description should not be taken as limiting the scope of the invention.

What is claimed is:

1. A bridgeless power factor correction apparatus, comprising,
an alternating current (AC) input having a first input terminal and a second input terminal;
an inductor module coupled with the first input terminal;
a switching module comprising a bi-directional voltage blocking switch coupled between the second input terminal and the inductor module, configured to selectively couple the inductor module with the AC input based on an output voltage and a phase difference between an input voltage waveform and an input current waveform; and
an output module coupled with the inductor module.

2. The apparatus of claim 1, wherein the inductor module comprises:
a first winding coupled with the AC input and the switching module; and
a second winding inductively coupled with the first winding and coupled with the output module.

3. The apparatus of claim 2, wherein the inductor module comprises a tapped inductor, and the second winding is common to a portion of the primary winding.

4. The apparatus of claim 1, wherein the output module comprises:
a coupling capacitor coupled with the inductor module;
a rectifier module coupled with the coupling capacitor and inductor module; and
an output capacitor coupled with the rectifier module.

5. The apparatus of claim 4, wherein the rectifier module comprises:
a first rectifier having an anode terminal coupled with a first output terminal; and
a second rectifier having an anode terminal coupled with a cathode terminal of the first rectifier and a cathode terminal coupled with a second output terminal, the first rectifier and second rectifier configured to operate substantially in anti-synchronization.

6. The apparatus of claim 5, wherein the switching module comprises two or MOSFETs, and the rectifiers comprise synchronous rectifiers.

7. The apparatus of claim 1, wherein the switching module comprises:
a main switch coupled between the second input terminal and the inductor module;
an auxiliary switch; and
an auxiliary capacitor,
the auxiliary switch and auxiliary capacitor coupled between one of the input terminals and the inductor module, the auxiliary switch configured to accomplish a reversal of current in the inductor module during an off time of the main switch to direct current in the inductor module towards the main switch to drive the main switch to zero volts during a turn on transition of the main switch.

8. A power factor correction apparatus, comprising,
an alternating current (AC) input having a first input terminal and a second input terminal;
an inductor module comprising a first winding and a second winding inductively coupled with the first winding, the first winding coupled with the first input terminal;
a switching module coupled between the second input terminal and the first winding, configured to selectively couple the first winding and second input terminal based on an output voltage and a phase difference between an input voltage waveform and an input current waveform; and
an output module coupled between the second winding and an output.

9. The apparatus of claim 8, wherein the switching module comprises:
a bi-directional voltage blocking switch coupled between the second input terminal and first winding; and
a controller module configured to switch the bi-directional voltage blocking switch based on the output voltage and phase difference between the input voltage waveform and the input current waveform.

10. The apparatus of claim 8, wherein the output module comprises:
a coupling capacitor coupled with the second winding,
a rectifier module coupled with the coupling capacitor and second winding; and
an output capacitor coupled with the rectifier module.

11. The apparatus of claim 10, wherein the rectifier module comprises:
a first rectifier having an anode terminal coupled with a first output terminal;
a second rectifier having an anode terminal coupled with a cathode terminal of the first rectifier and a cathode terminal coupled with a second output terminal, the first rectifier and second rectifier configured to operate substantially in anti-synchronization.

12. The apparatus of claim 8, wherein the inductor module comprises a tapped inductor, and the second winding is common to a portion of the primary winding.

13. The apparatus of claim 11, wherein the switching module comprises a semiconductor switch, and the rectifier module comprises semiconductor rectifiers.

14. The apparatus of claim 13, wherein said switch comprises two or MOSFETs.

15. The apparatus of claim 13, wherein the rectifiers comprise synchronous rectifiers.

16. The apparatus of claim 8, wherein the switching module comprises:
a main switch coupled between the second input terminal and a second terminal of the first winding;
an auxiliary switch; and
an auxiliary capacitor,
the auxiliary switch and auxiliary capacitor coupled between one of the input terminals and the second terminal of the first winding, the auxiliary switch configured to accomplish a reversal of current in the first winding during an off time of the main switch to direct current in the first winding towards the main switch to drive the main switch to zero volts during a turn on transition of the main switch.

17. A power factor correction apparatus, comprising,
an alternating current (AC) input having a first input terminal and a second input terminal;
inductor means coupled with the first input terminal;
witching means for coupling/decoupling the inductor means with the AC input based on an output voltage and a phase difference between an input voltage waveform and an input current waveform; and
output means for rectifying an output signal from the inductor means.

18. The apparatus of claim 17, wherein the inductor means comprise a coupled inductor, comprising:
a first winding coupled with the AC input and the switching means; and
a second winding inductively coupled with the first winding and coupled with the output means.

19. The apparatus of claim 18, wherein the switching means comprises:
a bi-directional voltage blocking switch coupled between the second input terminal and first winding; and
a controller module configured to switch the bi-directional voltage blocking switch based on the output voltage and phase difference between the input voltage waveform and the input current waveform.

20. The apparatus of claim 18, wherein the switching means comprises:
a main switch coupled between the second input terminal and a second terminal of the first winding;
an auxiliary switch; and
an auxiliary capacitor,
the auxiliary switch and auxiliary capacitor coupled between one of the input terminals and the second terminal of the first winding, the auxiliary switch configured to accomplish a reversal of current in the first winding during an off time of the main switch to direct current in the first winding towards the main switch to drive the main switch to zero volts during a turn on transition of the main switch.
